(19) United States
(12) Patent Application Publication
(10) Pub. No.: US 2015/0158520 A1
(43) Pub. Date: Jun. 11, 2015

(54) STEERING APPARATUS

(71) Applicant: Showa Corporation, Gyoda-shi (JP)

(72) Inventor: Naomasa WATANABE, Haga-gun (JP)

(73) Assignee: SHOWA CORPORATION, Gyoda-shi (JP)

(21) Appl. No.: 14/332,864

(22) Filed: Jul. 16, 2014

(30) Foreign Application Priority Data
Dec. 10, 2013 (JP) 2013-255185

(51) Int. Cl. B62D 3/12; B62D 5/04; F16F 7/09

(52) U.S. Cl. CPC B62D 3/126; F16F 7/095; B62D 5/04

(57) ABSTRACT

A steering apparatus includes: a steering shaft that moves in a vehicle width direction to cause a vehicle wheel to be steered; a stopper member provided on a side of an end portion of the steering shaft; a housing in which the steering shaft is housed; an elastic body provided in the housing and configured to come into contact with the stopper member and restrict movement of the steering shaft; and an enlarged diameter portion being formed between the steering shaft and the stopper member, the enlarged diameter portion coming into contact with the elastic body and having a diameter increasing from a steering shaft side toward a stopper member side.

### CROSS-REFERENCE TO RELATED APPLICATIONS

This application is based on and claims priority under 35 USC 119 from Japanese Patent Application No. 2013-255185 filed on Dec. 10, 2013, the entire content of which is incorporated herein by reference.

### BACKGROUND OF THE INVENTION

1. Technical Field

The present invention relates to a steering apparatus.

2. Related Art

As the mechanism of a steering apparatus that allows wheels of a four-wheeled vehicle to be steered, a rack and pinion mechanism, a ball nut mechanism, and the like are known. For example, the rack and pinion steering apparatus includes a pinion shaft with pinion teeth formed thereon, a rack bar with rack teeth formed thereon which mesh with the pinion teeth, the rack bar extending in a vehicle width direction, metal rack ends engaged with respective opposite end portions of the rack bar in a threaded manner, a cylindrical housing in which the rack bar is housed, and elastic bodies each formed of rubber and provided between the rack end and the housing to buffer impact (collision load) when the rack end collides against the elastic body (Patent Literature 1 (JP-A-2013-35481)).

### SUMMARY OF THE INVENTION

However, according to Patent Literature 1, the elastic body is elastically deformed to absorb an impulsive load. Thus, the elastic body needs to have an appropriate capacity (volume or size), hindering a reduction in the size of an elastic body and components around the elastic body of the steering apparatus.

Thus, an object of the present invention is to provide a steering apparatus that can be easily downsized.

An aspect of the present invention provides a steering apparatus including a steering shaft that moves in a vehicle width direction to cause a vehicle wheel to be steered, a stopper member provided on a side of an end portion of the steering shaft, a housing in which the steering shaft is housed, an elastic body provided in the housing and configured to come into contact with the stopper member and restrict movement of the steering shaft, and an enlarged diameter portion being formed between the steering shaft and the stopper member, the enlarged diameter portion coming into contact with the elastic body and having a diameter increasing from the steering shaft side toward the stopper member side.

In this configuration, when the steering shaft moves in the vehicle width direction, the enlarged diameter portion comes into contact with the elastic body. The amount of deformation of the elastic body in the radial direction gradually increases, thereby gradually decelerating the steering shaft.

After the steering shaft is thus decelerated, the stopper member comes into contact with the elastic body, restricting g movement of the steering shaft. This reduces the impulsive load input to the stopper member (steering shaft) through the elastic body. This in turn eliminates the need for an increase in the size of the elastic body, allowing easily an elastic body and components around the elastic body of the steering apparatus to be downsized.

Furthermore, in the steering apparatus, the enlarged diameter portion may be formed to be integrally connected with the steering shaft.

Additionally, in the steering apparatus, the enlarged diameter portion may be formed to be integrally connected with the stopper member.

In addition, in the steering apparatus, the enlarged diameter portion may be formed using an enlarged diameter portion forming member separate from the steering shaft and the stopper member.

The aspect of present invention can provide a steering apparatus that can be easily miniaturized.

### BRIEF DESCRIPTION OF THE DRAWINGS

FIG. 1 is a diagram showing a configuration of a steering apparatus according to a first embodiment;

FIG. 2A is an enlarged view of a specific part of the steering apparatus according to the first embodiment in a normal state (a noncontact state of an enlarged diameter portion), and FIG. 2B is an enlarged view of a specific part of the steering apparatus according to the first embodiment in a movement restriction state (a contact state of an enlarged diameter portion);

FIG. 3 is an enlarged view of a specific part of a steering apparatus according to a second embodiment in a normal state (a noncontact state of an enlarged diameter portion);

FIG. 4 is an enlarged view of a specific part of a steering apparatus according to a third embodiment in a normal state (a noncontact state of an enlarged diameter portion); and

FIG. 5 is an enlarged view of a specific part of a steering apparatus according to a fourth embodiment in a normal state (a noncontact state of an enlarged diameter portion).

### DETAILED DESCRIPTION OF THE INVENTION

### First Embodiment

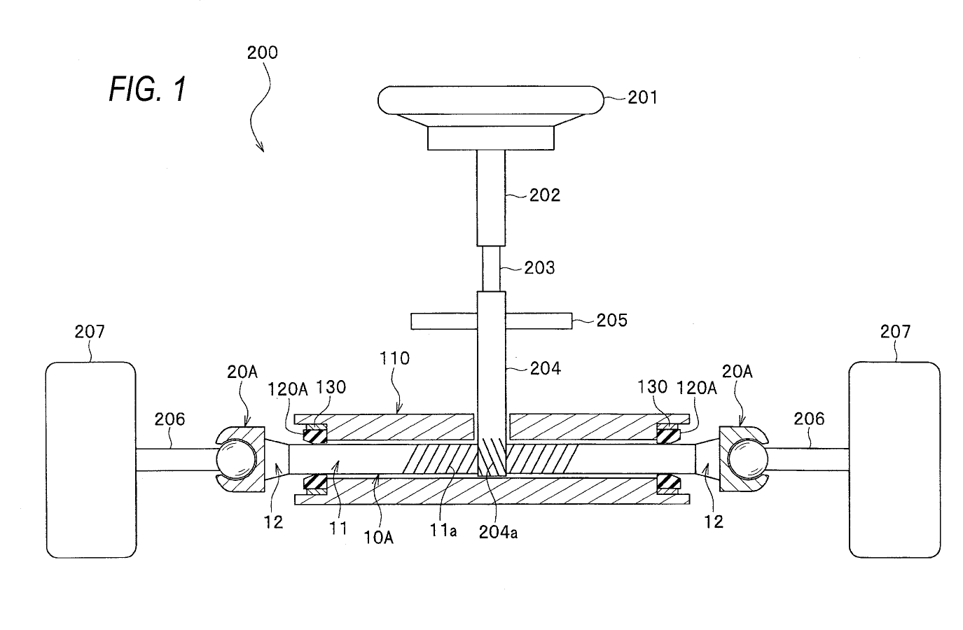

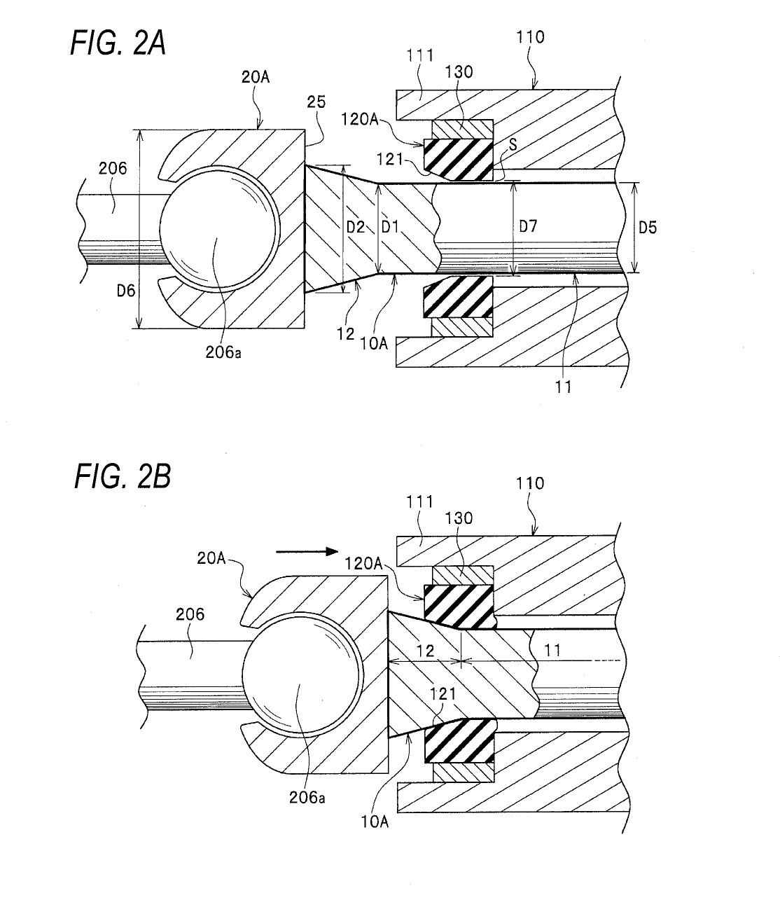

A first embodiment of the present invention will be described with reference to FIG. 1 and FIGS. 2A and 2B.

In the description below, an axial direction means the axial direction (longitudinal direction) of a rack bar 10A. A radial direction means the radial direction of the rack bar 10A, which is elongate and cylindrical. A vehicle-width outward side means a side closer to the exterior of the vehicle in the vehicle width direction (lateral direction). A vehicle-width inward side means a side closer to the center of the vehicle in the vehicle width direction.

<<Configuration of the Steering Apparatus>>

A steering apparatus 200 is a rack-and-pinion electric power steering apparatus of a pinion assist type in which an assist force exerted by an electric motor is input to a pinion shaft 204. However, the steering apparatus 200 may be of a column assist type or a rack assist type. Alternatively, the steering apparatus 200 may be a hydraulic power steering apparatus that generates an assist force using a hydraulic motor.

The steering apparatus 200 includes a steering wheel 201 operated by a driver, a steering shaft 202 (steering column) that rotates integrally with the steering wheel 201, a torsion bar 203 connected to a lower end of the steering shaft 202, a pinion shaft 204 connected to a lower end of the torsion bar 203, and a rack bar 10A.

A worm wheel 205 is coaxially fixed to the pinion shaft 204. In accordance with a torsional torque generated by the torsion bar 203, an assist force is input to the worm wheel 205 (pinion shaft 204) by an electric motor (not shown in the drawings).

Pinion teeth 204a of the pinion shaft 204 mesh with rack teeth 11a of the rack bar 10A. When the pinion shaft 204 rotates, the rack bar 10A moves in the vehicle width direction to allow steering of steered wheels 207 (vehicle wheels) connected to the rack bar 10A via respective tie rods 206.

Furthermore, the steering apparatus 200 includes rack ends 20A (stopper members) fixed to respective opposite ends of the rack bar 10A, a housing 110 in which the rack bar 10A is housed, elastic bodies 120A fixed in the housing 110.

<Rack Bar>

The rack bar 10A is a bar-like component that moves in the vehicle width direction to allow the steered wheels 207 to be steered. The rack bar 10A is slidably housed in the housing 110 via bearings (not shown in the drawings). The rack bar 10A is a metal component and includes a rack bar main body 11 (steering shaft) and enlarged diameter portions 12 formed on respective opposite end sides of the rack bar main body 11.

<Rack Bar Main Body>

The rack bar main body 11 is a bar-like component and includes the rack teeth 11a formed on the rack bar main body 11.

<Enlarged Diameter Portion>

The enlarged diameter portion 12 is a portion formed integrally on each end side of the rack bar main body 11. The enlarged diameter portion 12 includes a truncated cone-shaped portion located on a rack end 20A side (a vehicle-width outward side) and having an enlarged diameter. An outer peripheral surface of the truncated cone-shaped portion is a tapered surface having a diameter increasing toward the rack end 20A. That is, the enlarged diameter portion 12 is a component disposed between the rack bar main body 11 and the rack end 20A and which has an outer diameter gradually increasing from the rack bar main body 11 side toward the rack end 20A side; the enlarged diameter portion 12 gradually increases in thickness from the rack bar main body 11 side toward the rack end 20A side.

<Enlarged Diameter Portion—Vehicle-Width Inward Side>

An outer diameter D1 of a vehicle-width inward side of the enlarged diameter portion 12 can be formed to be the same as an outer diameter D5 of the rack bar main body 11.

However, the outer diameter D1 of the vehicle-width inward side of the enlarged diameter portion 12 may be smaller than the outer diameter D5 of the rack bar main body 11. In this configuration, a step recessed from the enlarged diameter portion 12 or circumferentially extending groove is formed between the enlarged diameter portion 12 and the rack bar main body 11.

Alternatively, the outer diameter D1 of the vehicle-width inward side of the enlarged diameter portion 12 may be larger than the outer diameter D5 of the rack bar main body 11. In this configuration, a step projecting upward from the enlarged diameter portion 12 is formed between the enlarged diameter portion 12 and the rack bar main body 11. This step is preferably smaller than a gap S formed between the rack bar main body 11 and the elastic body 120A in the radial direction.

<Enlarged Diameter Portion—Vehicle-Width Outward Side>

An outer diameter D2 of a vehicle-width outward side of the enlarged diameter portion 12 is preferably smaller than an outer diameter D6 of the rack end 20A. That is, the outer diameter D6 of the rack end 20A is larger than the outer diameter D2 of the vehicle-width outward side of the enlarged diameter portion 12. A ring-like collision surface 25 is formed on a vehicle-width inward side of the rack end 20A and around the enlarged diameter portion 12. When the collision surface 25 comes into abutting contact with the elastic body 120A and a collar 130, movement of the rack bar 10A is restricted.

However, at least a part of the enlarged diameter portion 12 acts as a stopper member to restrict movement of the rack bar 10A. Furthermore, the outer diameter D2 of the vehicle-width outward side of the enlarged diameter portion 12 may be the same as the outer diameter D6 of the rack end 20A.

<Rack End>

The rack end 20A is a stopper member fixed to each of the opposite ends of the rack bar 10A. The rack end 20A is shaped like a bottomed cylinder that is closed on the inward side in the vehicle width direction, and is fixed by being engaged with the rack bar 10A in a threaded manner. When the outer diameter D2 of the vehicle-width outward side of the enlarged diameter portion 12 is smaller than the outer diameter D6 of the rack end 20A, the collision surface 25, which collides against the elastic body 120A and the collar 130, is formed on the rack end 20A on the inward side in the vehicle width direction, as described above.

An inner surface of the rack end 20A is spherical so that a spherical head portion 206a of the tie rod 206 can be housed in the rack end 20A so as to be able to swing freely. That is, the rack end 20A and the tie rod 206 provide a ball joint.

<Housing>

The housing 110 is a cylindrical container in which the rack bar 10A is housed. The housing 110 is fixed to a vehicle body via a bolt or the like (not shown in the drawings). The housing 110 includes at each of the opposite ends thereof a mounting portion 111 which has an inner peripheral surface increasing in diameter in steps and in which the elastic body 120A is mounted.

<Elastic Body>

The elastic body 120A is a component provided in the housing 110 and coming into contact with the stopper member (rack end 20A) to restrict movement of the rack bar 10A. The elastic body 120A is a cylindrical, elastically deformable component formed of an elastic material such as rubber.

The elastic body 120A can be fixed to the housing 110 via the cylindrical metal collar 130. Specifically, the elastic body 120A is welded to an inner peripheral surface of the collar 130. The collar 130 is press fitted in the mounting portion 111 of the housing 110. The collar 130 is an adapter for mounting the elastic body 120A and is also a component with which the rack end 20A comes into abutting contact to restrict movement (stroke) of the rack bar 10A.

However, the collar 130 may be omitted and the elastic body 120A may be press fitted directly into the mounting portion 111. In this case, the rack end 20A comes into abutting contact with the elastic body 120A, which elastically deforms, to restrict movement (stroke) of the rack bar 10A.

An inner diameter D7 of the elastic body 120A is larger than the outer diameter D5 of the rack bar main body 11 so that the gap S is formed between the elastic body 120A and the rack bar main body 11. That is, the rack bar main body 11 is loosely inserted into the elastic body 120A. Thus, the rack bar 10A can move without any sliding resistance or the like from the elastic body 120A.

A tapered surface 121 may be formed on a widthwise outward side of an inner peripheral surface of the elastic body 120A. That is, the inner peripheral surface of the elastic body 120A may have a diameter increasing outward in the vehicle width direction. This allows adjustment of the degree to which the enlarged diameter portion 12 absorbs an impact load, adjusting the feeling of steering limits. Moreover, the taper angle (inclination angle) of the tapered surface 121 and the axial length of the tapered surface 121 can be changed to adjust the degree to which the enlarged diameter portion 12 absorbs the impact load.

However, the elastic body 120A may omit the tapered surface 121 and may be a cylinder.

<<Effects of the Steering Apparatus>>

The steering apparatus 200 exerts the following effects.

When the steering wheel 201 is operated to rotate the steering shaft 202 and the pinion shaft 204 to move the rack bar 10A in the vehicle width direction, the enlarged diameter portion 12 is pushed into the elastic body 120A, while colliding against the elastic body 120A (see FIG. 2B).

In this case, since the enlarged diameter portion 12 increases outward in the vehicle width direction in diameter and thickness, the amount by which the elastic body 120A is deformed gradually increases as the enlarged diameter portion 12 is pushed in. Thus, the enlarged diameter portion 12 (rack bar 10A) gradually decelerates. After the gradual deceleration of the enlarged diameter portion 12 (rack bar 10A), the rack end 20A comes into abutting contact with the elastic body 120A and the collar 130 to restrict movement of the rack bar 10A.

As described above, after the gradual deceleration of the rack bar 10A, the rack end 20A comes into abutting contact with the elastic body 120A and the like to reach the steering limit. This provides an appropriate steering feeling. Furthermore, the apparatus has a simple configuration in which the rack bar 10A includes the enlarged diameter portion 12. This eliminates the need for an increase in the size of the elastic body 120A, causing the elastic body 120A and components around the elastic body of the steering apparatus 200 to be easily downsized. Moreover, the rack end 20A is prevented from colliding rapidly against the collar 130. Thus, the pinion teeth 204a and the rack teeth 11a are unlikely to be subjected to deformation and the like, preventing loads from acting rapidly on, for example, a motor generating an assist force.

<<Variation>>

An embodiment of the present invention has been described. However, the present invention is not limited to the embodiment but may be varied, for example, as follows.

In the first embodiment, the configuration has been illustrated in which the steering apparatus 200 is of the rack and pinion type. However, the steering apparatus 200 may be of a ball nut type or a steering gear box type. If the steering apparatus 200 is of the ball nut type, the steering shaft, which moves in the vehicle width direction in order to allow the vehicle wheels to be steered, is a steering shaft extending in the vehicle width direction.

In the first embodiment, the steering apparatus 200 has been illustrated in which the steering shaft 202 and the pinion shaft 204 are mechanically connected together via the torsion bar 203. However, the steering apparatus may be a steer by wire type in which the steering shaft is not mechanically connected to an input apparatus such as the steering wheel 201.

### Second Embodiment

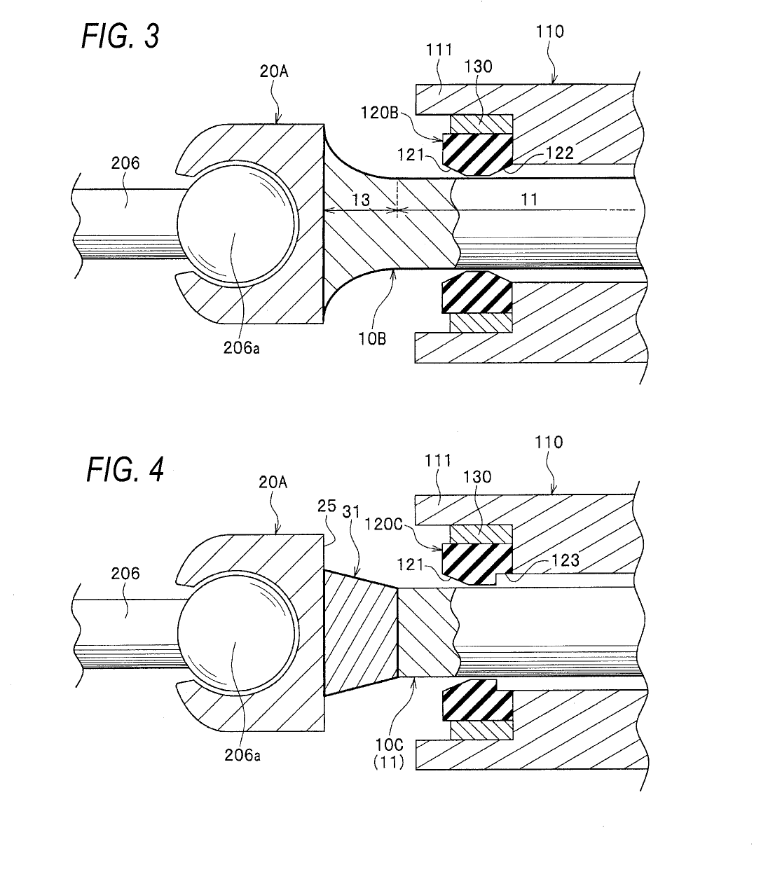

A second embodiment of the present invention will be described with reference to FIG. 3. Differences from the first embodiment will be chiefly described.

As shown in FIG. 3, a rack bar 10B according to the second embodiment includes a rack bar main body 11 and an enlarged diameter portion 13. An outer peripheral surface of the enlarged diameter portion 13 is shaped like a quarter of a circle (appears to have a round shape) in cross section. That is, the degree to which the enlarged diameter portion 13 projects from a central axis increases toward a rack end 20A.

An elastic body 120B according to the second embodiment includes a tapered surface 121 formed on a vehicle-width outward side of an inner peripheral surface of the elastic body 120B.

A corner portion of the elastic body 120B inward in the vehicle-width direction is cut out. Thus, when the elastic body 120B is elastically deformed, it is unlikely that a part of the elastic body 120B thrusts into the gap between the housing 110 and the rack bar 10B.

### Third Embodiment

A third embodiment of the present invention will be described with reference to FIG. 4. Differences from the first embodiment will be chiefly described.

As shown in FIG. 4, a steering apparatus according to the third embodiment includes a rack bar 10C (rack bar main body 11), a rack end 20A, and an enlarged diameter portion forming member 31 (tapered member) separate from the rack bar 10C and the rack end 20A (the enlarged diameter portion forming member 31 is a separate component). The enlarged diameter portion forming member 31 is an independent component for forming an enlarged diameter portion.

For example, the enlarged diameter portion forming member 31 includes a through-hole formed in the center of the enlarged diameter portion forming member 31. A screw stock (not shown in the drawings) extending from an end surface of the rack bar 10C engages, in a threaded manner, with a threaded hole in the rack end 20A through the through-hole to integrate the rack bar 10C, the rack end 20A, and the enlarged diameter portion forming member 31 together.

An elastic body 120C according to the third embodiment includes an enlarged diameter surface 123 formed on a vehicle-width outward side of an inner peripheral surface of the elastic body 120C so as to provide a step. The elastic body 120C is cut out in a vehicle-width inward corner portion thereof. Thus, when the elastic body 120C is elastically deformed, it is unlikely that a part of the elastic body 120C thrusts into the gap between a housing 110 and the rack bar 10C.

### Fourth Embodiment

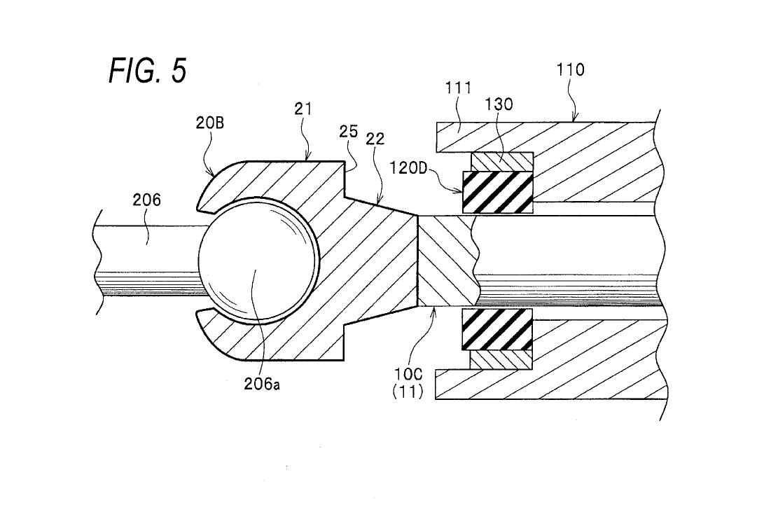

A fourth embodiment of the present invention will be described with reference to FIG. 5. Differences from the first embodiment will be chiefly described.

As shown in FIG. 5, a steering apparatus according to the fourth embodiment includes a rack bar 10C (rack bar main body 11) and a rack end 20B, and has an enlarged diameter portion 22 formed on the rack end 20B side. That is, the rack end 20B includes a rack end main body 21 and the enlarged diameter portion 22. The enlarged diameter portion 22 is shaped like a truncated cone having a diameter gradually increasing toward the rack end main body 21 side. An enlarged diameter portion may also be formed to be integrally connected with the rack bar 10C.

Furthermore, An elastic body 120D according to the fourth embodiment is shaped like a cylinder and includes neither the tapered surfaces 121 and 122 (see FIGS. 2A and 2B and FIG. 3) nor the enlarged diameter surface 123 (see FIG. 4). Hence, the elastic body 120D can be easily formed using a mold.

What is claimed is:

1. A steering apparatus comprising:
a steering shaft that moves in a vehicle width direction to cause a vehicle wheel to be steered;
a stopper member provided on a side of an end portion of the steering shaft;
a housing in which the steering shaft is housed;
an elastic body provided in the housing and configured to come into contact with the stopper member and restrict movement of the steering shaft; and
an enlarged diameter portion being formed between the steering shaft and the stopper member, the enlarged diameter portion coming into contact with the elastic body and having a diameter increasing from a steering shaft side toward a stopper member side.

2. The steering apparatus according to claim 1, wherein the enlarged diameter portion is formed to be integrally connected with the steering shaft.

3. The steering apparatus according to claim 1, wherein the enlarged diameter portion is formed to be integrally connected with the stopper member.

4. The steering apparatus according to claim 1, wherein the enlarged diameter portion is formed by using an enlarged diameter portion forming member, which is a member separate from the steering shaft and the stopper member.
